(19) United States
(12) Patent Application Publication
(10) Pub. No.: US 2010/0241553 A1
(43) Pub. Date: Sep. 23, 2010

(54) Method for Calculating an Index

(76) Inventor: Ran GORENSTEIN, Antwerp (BE)

Correspondence Address: HANCOCK HUGHEY LLP, P.O. BOX 6553, PORTLAND, OR, 97228, US

(21) Appl. No.: 12/729,854

(22) Filed: Mar. 23, 2010

(30) Foreign Application Priority Data
Mar. 23, 2009 (GB) 0904909.9

(51) Int. Cl. G06Q 40/00; G06Q 50/00

(52) U.S. Cl. 705/37; 705/35

(57) ABSTRACT

A system and method for calculating an index relating to the trading of diamonds conforming to a particular profile, that thus makes diamonds amenable for derivative trading via futures contracts or the like.

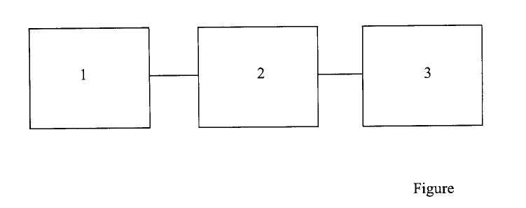

### FIELD OF THE INVENTION

This invention relates to a method for calculating an index, and in particular concerns a method for calculating a financial index, for derivatives trading, corresponding to cut diamonds.

### BACKGROUND AND SUMMARY OF THE INVENTION

There are many indices relating to various commodities that are commonly bought or sold, such as gold, silver and oil. Commodities such as these are generally sold in a standard or agreed quality, form and/or purity, for instance 24 carat gold or “West Texas Intermediate” crude oil. The price at which a commodity of this nature is currently being traded can therefore readily be represented by an index, which generally takes the form of a single number.

As will be well understood by those skilled in the art, indices of this type are often used in trading of derivatives, such as options and futures. A trader may predict that an index relating to a commodity will have risen or fallen by a certain amount after a pre-set length of time, and buy options or futures in that commodity accordingly.

The trading of precious stones, such as diamonds, does not easily lend itself to representation by a single index of this type. Diamonds occur in a wide range of different sizes, and also may differ in qualities such as colour, quality (i.e. internally flawlessness), fluorescence and cut, with the price of the diamond being heavily influenced by variations in these parameters. Therefore, the price for which one diamond has been sold does not provide a simple indication of the price for which another diamond will sell. As a result, while large quantities of information and price guides are provided relating to prices of different diamonds, such as the information provided by the Rapaport company, few indices relating to diamond trading presently exist.

One index, provided under the trade name “Idex,” provides 15 different indices, each being representative of the asking prices of a certain category of diamonds, with each category being defined by ranges of weight, colour, quality and cut. In addition to these separate indices, one overall index is defined, which comprises a weighted average of the fifteen category-specific indices. The Idex index is calculated on the basis of asking prices for various types of diamonds.

Other indices of similar types are provided under the trade names “Dodaq” and “Polished Prices.”

It is an object of the present invention to seek to provide an alternative and improved method of this type.

Accordingly, one aspect of the present invention provides a system for establishing an index relating to the prices of diamonds conforming to a predetermined diamond profile, comprising: computing means for: receiving sale data relating to the finalised selling prices of real diamonds which have been traded, the sale data including at least the price and weight of a diamond that has been sold, and an indication that the diamond conforms to the predetermined diamond profile; comparing the weight of each diamond to a predefined price-weight relation, to determine an expected price per unit weight for each diamond; calculating, for each diamond, a value based on the weight of the diamond and the expected price per unit weight; and using the values for plural diamonds, having different expected prices per unit weight, directly in the calculation of a single index value, and display means associated with the computing means for outputting the index value for use by traders.

In an embodiment, the step of calculating a value for a diamond comprises establishing an expected price for the diamond.

In an embodiment, the diamond profile specifies at least one of the colour, quality and cut of diamonds.

In an embodiment, the diamond profile specifies a particular colour, quality and cut of diamonds.

In an embodiment, the diamond profile specifies a particular quality and cut of diamonds.

In an embodiment, the profile specifies that diamonds are internally flawless and round-brilliant cut.

In an embodiment, a purity evaluation machine is used to provide a determination as to the purity of a diamond whose trading price is to be used in the calculation of the index.

In an embodiment, a colour evaluation machine is used to provide a determination as to the colour of a diamond whose trading price is to be used in the calculation of the index.

Another aspect of the present invention provides, a system for establishing an index relating to the prices of diamonds conforming to a predetermined diamond profile, comprising: computing means for: defining a plurality of diamond categories, each category being defined by a at least a range of weight; receiving sale data relating to the finalised selling prices of real diamonds which have been traded, the sale data including at least the price and weight of a diamond that has been sold, and an indication that the diamond conforms to the predetermined diamond profile; assigning each diamond to the appropriate category based upon at least the weight of the diamond, and determining a price per unit weight for the diamond; calculating a single index value by determining a linear summation of at least one price per unit weight from each of the categories, display means associated with the computing means for outputting the index value for use by traders.

Another aspect of the present invention provides, a method for establishing an index relating to the prices of diamonds conforming to a predetermined diamond profile, comprising the steps of: receiving sale data relating to the finalised selling prices of real diamonds which have been traded, the sale data including at least the price and weight of a diamond that has been sold, and an indication that the diamond conforms to the predetermined diamond profile; calculating a single index value based on the sale data; and offering derivatives trading based upon the index value.

In an embodiment, the diamond profile specifies at least one of the colour, quality and cut of diamonds.

In an embodiment, the diamond profile specifies that diamonds fall into the highest category of colour and/or quality.

In an embodiment, the diamond profile specifies the colour, quality and cut of diamonds.

In an embodiment, the diamond profile specifies that diamonds are internally flawless and round-brilliant cut.

In order that the present invention may be more readily understood, embodiments therefore will now be described, by way of example, with reference to the accompanying FIGURE.

### BRIEF DESCRIPTION OF THE DRAWINGS

The FIGURE shows a schematic diagram of a system embodying the present invention.

### DETAILED DESCRIPTION OF A PREFERRED EMBODIMENT

Referring firstly to the FIGURE, a schematic view of a system embodying the present invention is shown. A first data input 1 receives sale data relating to the finalised prices at which various diamonds have actually been sold.

The source and type of the sale data is of importance in the present invention. While, as discussed above, indices relating to diamonds do exist, these indices are considered by some not to be sufficiently reliable for trading such as derivatives trading to take place on the basis of the index. One reason for this is that at least some of the indices are based upon asking prices, or other market information not comprising actual finalised trading prices. Another is that, where real sale data is used, the data only covers a selection of sales, typically those that a particular trader or company chooses to report. Not only does this reduce the accuracy of the index as an indicator of market activity, but the index is left open to manipulation by traders who will report only sales that are favourable to them (for instance, unusually high sale prices for sellers, unusually low prices for buyers).

In preferred embodiments of the invention, the information is substantially real-time information, being presented within a short space of time, such as within a few minutes, of a trade having been made. The first data input 1 may be adapted to gather or receive information from one or more information sources, which in preferred embodiments comprise online sources, such as websites, involved with diamond trading, and may continuously observe these websites so that information relating to new trades is gathered as quickly as possible. Alternatively, or in addition, one or more human users may send information relating to new trades electronically to the first data input, for instance by e-mail (although it is preferred that such users are impartial so that all, rather than some, sales of a certain type are reported). Further, information may be received relating to all sales finalised in one or more physical auction houses, such as Christie's® or Sotheby's®.

Skilled readers will be aware of other methods by which the first data input may receive real-time or substantially real-time data concerning the finalised prices at which diamonds have been traded.

It will be appreciated that most of the currently-available indices are provided by companies whose primary concern is the sale of diamonds. A trader may therefore be unsure of the impartiality of such an index, since the provider of the index may have an interest in the prices of diamonds appearing to rise or fall at a particular time. Gathering information relating to all, or substantially all, diamond trades from relevant sources will help reassure traders that the index is objectively calculated.

Sale data relating to the trading of one or more diamonds must specify certain facts concerning the trade. These facts include the weight of the diamond(s) that have been traded, preferably in carats, and also an indication of certain additional parameters of the diamond(s), such as the cut, colour and quality of the diamonds. The additional parameters may be received in the form of an individual value for each parameter, or a single value may be received which confirms that the diamond(s) that have been traded conform to a pre-defined parameter profile, as will be discussed in more detail below.

The first data 1 input receives sale data, as discussed above, and transmits the data to a main processor 2, which processes the data and calculates an index. The index is output by the main processor in any convenient form, and may be transmitted to interested parties 3 such as traders, stock exchanges or auctioneers.

The calculation of the index will now be described in more detail. In general, heavier diamonds (i.e. those of a greater carat weight) will trade for higher prices, in terms of price per unit weight, than less heavy diamonds. This is partly because heavy diamonds are much rarer than less heavy diamonds, but also because according to current fashions large diamonds are preferred by consumers. The prices of diamonds do not, therefore, rise in a linear fashion with increasing weight, but increase more sharply with increasing weight, heavier diamonds being disproportionately more expensive than less heavy diamonds.

As discussed above, it is desired to present a single index relating to diamond prices. Systems embodying the present invention perform calculations based on the assumption that the relationship between the prices of diamonds of varying weights will remain constant, at least over short periods. A model of the variation of diamond prices with respect to weight is therefore provided as part of the system. As an example, a crude model might assume that the price of diamonds (having otherwise identical properties) would vary in proportion to the square or cube of the weight of the diamond.

At present prices, the price of a 1-carat D-colour, round-brilliant cut, internally flawless diamond may be approximately $10,000, whereas the price of a 10-carat stone having identical properties may be around $1,000,000 (i.e. $100,000 per carat). Based on these rough prices, a simple model might assume that the price per carat varies between these limits according to a simple square or cube relationship. It should be appreciated, however, that the price model may be much more complicated than this, and indeed may take any suitable form. The model may be set up so that different relationships are followed within different price ranges. For instance, the price per carat may be proportional to the square of the weight between 1 and 3 carats, proportional to the cube of the weight between 3 and 6 carats, and so on.

Instead of following a mathematical relationship like that discussed above, the model may comprise a price-relation curve which is based upon data points which have been manually entered, based upon empirical and/or historical trading data, or any other suitable information.

Importantly, however, a relationship is established between the weights of various diamonds and their relative prices. The relationship comprises a continuous formula, a series of values or co-ordinates, or a combination of the two, relating a particular weight, or range of weights, with a quantity relating to price or relative price.

It is anticipated that several weight categories may be defined, and traded diamonds may be allocated to the appropriate category. For instance, to encompass diamonds having weights from 1 to 15 carats, the weight categories may be defined between the following carat values:

1.01-1.19
1.20-1.49
1.50-1.74
1.75-1.99
2.00-2.49
2.50-2.99
3.00-3.49
3.50-3.99
4.00-4.49
4.50-4.99
5.00-5.99
6.00-6.99
7.00-7.99
8.00-8.99
9.00-9.99
10.00-15.00
with a price per carat (or another unit of weight or mass) being defined in each category.

When sale information is received relating to one or more diamonds, the main processor 2 uses the weight of each diamond, and the price at which the diamond was traded, to arrive at a compensated trading value for that diamond. The compensated trading value takes into account the relative prices of diamonds having different weights.

For instance, the compensated trading value might be obtained by dividing the actual trading price by the anticipated price for a diamond of that weight. The trading price of a 1 carat diamond would therefore be divided by 10,000, and the trading price of a 10 carat diamond would be divided by 1,000,000. It will be appreciated that, if the prices at which a 1 carat diamond and a 10 carat diamond were traded were exactly as expected, then the compensated trading value for each of the trades would be 1.

In general, when a diamond having an arbitrary weight is traded, the main processor 2 will refer to the price-weight relation to obtain the expected price of a diamond of that weight, by multiplying the actual weight of the diamond by the expected price per carat. If categories such as those described above are used, then the expected price per carat will be that associated with the weight category into which the diamond falls. If a continuous price-weight relation is defined by a series of data points, and there is no data point which matches exactly or substantially the weight of a diamond that has been traded, the expected price can be calculated by interpolating between the data points. Any suitable type of interpolation may be used, for instance simply by extending a straight line between the two points either side of the actual weight, or by using a more sophisticated method such as cubic spline interpolation.

The compensated trading values can then be used directly to generate a single index, by any suitable method, relating to the price of D-colour, internally flawless, round-brilliant cut diamonds. It is anticipated that methods used to calculate trading indices for commodities such as gold or oil may be used. For instance, the most recent value may be used, or an average (which may be a weighted average) of values gathered over a period may be used.

The values are preferably used “directly”, in that they are not first used to calculate a separate index or sub-index which is itself used in the calculation of the main index.

In advantageous embodiments of the invention, trading data that is received through the first data feed 1 is associated with time information, either indicating the time at which the trade took place, or the length of time since the trade took place. The system may then disregard the information if the length of time since the trade is too great (for instance, greater than 30 minutes, 1 hour, 2 hours, or any other suitable length of time), or may use the information in the calculation of the index but give the information a reduced weighting.

It will be appreciated that the system described above assumes that the relative prices of diamonds of different weights will not change. The system will therefore function well if the prices of all weights of D-colour, internally flawless, round-brilliant cut diamonds doubles, or halves, as long as the ratios of the prices remains the same. However, it is appreciated that the relative price ratios may not always remain the same.

In preferred embodiments of the invention, therefore, the main processor 2 also performs a check to determine whether diamonds of different weights are regularly being traded at values which are significantly different from the ratio expressed by the pre-set price-weight relation. There are several ways in which this may be achieved.

For instance, a number of specific weights may be defined, such as 1 carat, 5 carats and 10 carats. At regular intervals the ratios between the average trading prices of diamonds having these weights (or falling within a pre-set range immediately around these weights, such as 0.1 carats) may be compared. If these ratios are significantly different from those anticipated, the main processor may generate an alert, so that an operator of the system can analyse the trading prices and adjust the price-weight relation, if necessary, to reflect the current relative trading prices.

Alternatively, the main processor 2 may accumulate data relating to the prices at which diamonds of various weights have been traded over a certain period of time, for instance one 24-hour period, and generate a current price-weight curve. The current curve can be compared against the pre-set price-weight relation to identify significant discrepancies. If any such discrepancies are found, again an alert may be generated so that an operator of the system can take any appropriate action.

In still further embodiments of the invention, the main processor 2 may be operable to adapt the price-weight relation in response to current trading prices. As discussed above, data relating to the trading prices of diamonds of various weights may be accumulate over a period of time, to generate a current price-weight curve. This current price-weight curve may then be used as the pre-set price weight relation, replacing the previously-used price weight relation. The accumulation of new data to produce a more up-to-date price-weight relation may then begin.

In a further, alternative embodiment of the invention, the index may be determined by calculating a linear sum of the price per unit weight in each of a plurality of categories that are at least partly determined by weight. For instance, a plurality of categories may be defined, as above, to contain D-colour, internally flawless, round-brilliant cut diamonds falling within certain weight ranges. As an example, the price per carat in these categories may be:

| Weight range (carat) | Price per carat ($) |
|---|---|
| 1.01-1.19 | 12,700 |
| 1.2-1.49 | 21,100 |
| 1.5-1.74 | 24,000 |
| 1.75-1.99 | 30,000 |
| 2.00-2.49 | 35,000 |
| 2.50-2.99 | 42,000 |
| 3.00-3.49 | 45,000 |
| 3.50-3.99 | 50,000 |
| 4.00-4.99 | 55,000 |
| 5.00-5.99 | 65,000 |
| 6.00-6.99 | 75,000 |
| 7.00-7.99 | 80,000 |
| 8.00-8.99 | 95,000 |
| 9.00-9.99 | 105,000 |
| 10.00-14.99 | 115,000 |

The index may then be calculated by summing the price per carat in each category, and in this instance the index would be 849,800. The index may, of course, comprise a number which is the sum of the prices multiplied or divided by a pre-set factor. Preferably the calculation of the index comprises a linear sum, meaning that no differential weighting is applied to the price per carat values from different categories.

In preferred embodiments, the price per carat in each category is based upon the single most recent sale (about which information is available) of a diamond falling within the category. The index may be updated at regular intervals, for instance once a day, twice a day or every hour, with the most recent values available at that time being used. Alternatively, the index may be updated as and when a new value is received in every category, or when a certain number of new values have been received, for instance five or ten new values.

It will be appreciated that this approach provides an intuitive and representative index. In particular, proportional shifts in the price per carat of heavier diamonds will influence the index to a greater extent. For instance, in the above example, a 10% increase in the price per carat for the 2.00-2.49 carat range will increase the overall index by 0.4%. A 10% increase in the price per carat for the 10.00-14.99 carat range will increase the overall index by 1.3%. It will be understood that, for many people, this will represent a fair reflection of real changes in the diamond market.

It will be appreciated that embodiments of the present invention will confer significant advantages with respect to known methods.

Firstly, real trading prices (i.e. the prices at which diamonds have actually been sold) are used, instead of asking prices. As will be well understood, diamonds normally sell for appreciably less than the asking price. An index based on the asking prices of diamonds is therefore not wholly reflective of actual market activity, and consumers or traders may place less confidence in a system based on asking prices.

Secondly, the restriction of the system to internally flawless diamonds improves the clarity and reliability of the resulting index. As those skilled in the art will know, there are several types of inclusions that may occur in a diamond to result in the diamond being classified as “very slightly included” (or of a lesser quality). This introduces considerable uncertainty, however.

For instance, black inclusions, chips, clouds or white bubbles may appear in a diamond. Stones having black inclusions or chips are considered to be of lesser value than diamonds having clouds or white bubbles.

In addition, inclusions can affect the density of the diamond. Black inclusions arise from a different form of carbon, and white bubbles are pockets of air. Both of these are of a lesser density than tetrahedral carbon (the principal material from which diamonds are formed), and so a diamond of a particular weight will be larger if it contains certain types of inclusions.

It will therefore be understood that diamond trading within the “very slightly included” category is not entirely consistent. Factors such as this reduce the reliability of the index that is produced by the system.

Further, a round-brilliant cut is uniquely defined. Other styles of cut, such as princess or marquise cuts, may contain variations in relative dimensions. One princess cut diamond may have a larger length/width ratio than another, and the value may vary depending on this ratio, as some ratios will be more aesthetically pleasing than others. Basing an index on princess-cut diamonds would therefore introduce an element of uncertainty that is not present if the index is based on round-brilliant cut diamonds.

Similar considerations may apply to colour. A D-colour diamond has no visible deviations from a pure white colour. However, the E-colour category is defined more subjectively, and encompasses a range of colours. Since diamonds are inspected and traded on an individual basis, a “good” E-colour diamond may sell for more than a “bad” E-colour diamond which has otherwise identical properties. However, it is expected that the index may be sufficiently reliable if colours other than D-colour are included in the calculation.

Thirdly, embodiments of the present invention can generate an index that can be related to a “benchmark” type of diamond, preferably a D-colour, internally flawless, brilliant-cut diamond. Users of the index, such as professional traders and members of the public, will prefer this as the index will be more obviously tied to the trading to a well-defined and readily understood commodity.

The diamond profile may be further refined to include any or all of: zero fluorescence, excellent cut grade, excellent polish and excellent symmetry.

In preferred embodiments, each item of sale data must include a certificate attesting to the properties of the diamond(s) that have been sold, for instance a certificate issued by the Gemological Institute of America (GIA). It is preferred that, whichever type of certificate is chosen, all diamond trades upon which the index is based are supported by the same type of certificate. Once again, this will increase the confidence that traders and the like will have in the resulting index.

In preferred embodiments of the invention, one or more machines may be used to provide accurate and objective determinations or one or more of the properties of diamonds whose trading prices are to be used in the calculation of the index.

For instance, a purity evaluation machines may be provided to measure the purity of a diamond, i.e. to determine whether it is internally flawless, or whether it falls into another category, such as “slightly included.” Such a machine may rely on the transmission of visible light, for example, or of another type of radiation such as X-rays. The purity evaluation machine may provide a determination that a particular diamond is internally flawless to a level that corresponds to no flaws being visible to the human eye under 10 times magnification, or to any other suitable level.

It will be appreciated that using a purity evaluation machine will reduce the potential subjectivity introduced by the use of the human eye to judge the purity of a diamond. This will increase the reliability of the index.

Similarly, a colour evaluation machine may be used to provide an automatic determination as to the colour of a diamond. Once again, the machine may rely on the transmission or reflection of any suitable radiation, or any other suitable method. Use of a machine of this type to determine whether a diamond is of a certain colour category, for instance D-colour, will again reduce subjectivity and increase the reliability of the index.

It is anticipated that indices generated by systems embodying the present invention will be used by traders for derivatives trading, in particular trading in futures contract or options contract (“futures” and “options”) based on the index. Such trading is currently offered on the basis of any indices relating to diamond pricing, but has not been widely used. A skilled user will understand that the price of a future or an option will depend on the index price at any given time, as well as the market volatility. An end date (the “strike date”) will be set, and at that date the trader has the option or obligation to buy diamonds at an agreed price (the “strike price”). It is anticipated that most traders will prefer to take a cash settlement, rather than delivery of any real diamonds, but it is anticipated that a delivery of diamonds may be made for an appropriate surcharge. While it cannot be guaranteed that a single diamond having a given value will be available, a collection of diamonds whose collective price is equal to that value may be delivered.

To implement derivatives trading based upon the index, it is envisaged that a private exchange may be set up. This exchange may preferably be a “virtual exchange” but may alternatively, or in addition, comprise one or more physical locations. The exchange would manage transactions between buyers and sellers, based on the price of the index, as discussed above.

It is envisaged that the exchange will be privately owned. Entities who wish to trade through the exchange, such as banks and individual traders, may be required to become members of the exchange in order to do so and may be charged for membership, and the exchange may also require fees to be paid as trading progresses, for instance, a certain percentage of funds which are paid out when derivatives contracts are concluded. Alternatively, or in addition, the exchange may be run through a market-maker such as a bank, who may receive a royalty relating to each transaction, or to a certain volume of transactions.

While the system described above relates only to D-colour, internally flawless, brilliant-cut diamonds, a skilled person will appreciate that the system can be adapted to accommodate diamonds having other properties. For instance, 16 weight categories are given in the example above. For each category, a price per carat could be defined for diamonds that are of D-colour and also of E-colour, so that a grid of 32 different price-colour categories are defined, each with an associated price per carat.

It is anticipated that indices calculated in accordance with the invention will provide certainty for all participants in the diamond industry, including traders, jewellers, miners/mining companies and banks

While the foregoing description was made in the context of a preferred embodiment, it is contemplated that modifications to that embodiment may be made without departure from the invention as claimed.

1. A system for establishing an index relating to the prices of diamonds conforming to a predetermined diamond profile, comprising:
computing means for:
receiving sale data relating to the finalised selling prices of real diamonds which have been traded, the sale data including at least the price and weight of a diamond that has been sold, and an indication that the diamond conforms to the predetermined diamond profile;
comparing the weight of each diamond to a predefined price-weight relation, to determine an expected price per unit weight for each diamond;
calculating, for each diamond, a value based on the weight of the diamond and the expected price per unit weight; and
using the values for plural diamonds, having different expected prices per unit weight, directly in the calculation of a single index value, and
display means associated with the computing means for outputting the index value for use by traders.

2. A system according to claim 1, wherein the step of calculating a value for a diamond comprises establishing an expected price for the diamond.

3. A system according to claim 1, wherein the diamond profile specifies at least one of the colour, quality and cut of diamonds.

4. A system according to claim 3, wherein the diamond profile specifies a particular colour, quality and cut of diamonds.

5. A system according to claim 3, wherein the diamond profile specifies a particular quality and cut of diamonds.

6. A system according to claim 4, wherein the profile specifies that diamonds are internally flawless and round-brilliant cut.

7. A system according to claim 1, wherein a purity evaluation machine is used to provide a determination as to the purity of a diamond whose trading price is to be used in the calculation of the index.

8. A system according to claim 1, wherein a colour evaluation machine is used to provide a determination as to the colour of a diamond whose trading price is to be used in the calculation of the index.

9. A system for establishing an index relating to the prices of diamonds conforming to a predetermined diamond profile, comprising:
computing means for:
defining a plurality of diamond categories, each category being defined by a at least a range of weight;
receiving sale data relating to the finalised selling prices of real diamonds which have been traded, the sale data including at least the price and weight of a diamond that has been sold, and an indication that the diamond conforms to the predetermined diamond profile;
assigning each diamond to the appropriate category based upon at least the weight of the diamond, and determining a price per unit weight for the diamond;
calculating a single index value by determining a linear summation of at least one price per unit weight from each of the categories,
display means associated with the computing means for outputting the index value for use by traders.

10. A method for establishing an index relating to the prices of diamonds conforming to a predetermined diamond profile, comprising the steps of:
receiving sale data relating to the finalised selling prices of real diamonds which have been traded, the sale data including at least the price and weight of a diamond that has been sold, and an indication that the diamond conforms to the predetermined diamond profile;
calculating a single index value based on the sale data; and
offering derivatives trading based upon the index value.

11. A method according to claim 10, wherein the diamond profile specifies at least one of the colour, quality and cut of diamonds.

12. A method according to claim 11, wherein the diamond profile specifies that diamonds fall into the highest category of colour and/or quality.

13. A method according to claim 11, wherein the diamond profile specifies the colour, quality and cut of diamonds.

14. A method according to claim 13, wherein the diamond profile specifies that diamonds are internally flawless and round-brilliant cut.
